(19) United States
(12) Patent Application Publication
(10) Pub. No.: US 2021/0294414 A1
(43) Pub. Date: Sep. 23, 2021

(54) INFORMATION PROCESSING APPARATUS, INFORMATION PROCESSING METHOD, AND PROGRAM

(71) Applicant: SONY CORPORATION, TOKYO (JP)

(72) Inventors: EISUKE NOMURA, TOKYO (JP); YUSUKE NAKAMURA, TOKYO (JP); YUKI YAMAMOTO, TOKYO (JP)

(21) Appl. No.: 17/250,539

(22) PCT Filed: Jul. 29, 2019
(86) PCT No.: PCT/JP2019/029614

§ 371 Date: Feb. 1, 2021

(30) Foreign Application Priority Data
Aug. 9, 2018 (JP) 2018-149839

(51) Int. Cl. G06F 3/01; G02B 27/00; G05D 1/00; G05D 1/02; G02B 27/01

(52) U.S. Cl. CPC G06F 3/013; G02B 27/0093; G02B 27/017; G05D 1/0223; G05D 1/0016

(57) ABSTRACT

[Object] To provide an information processing apparatus, an information processing method, and a program that make it possible to properly determine whether a user is gazing a mobile object even if an intermediate object exists between the user and a mobile object. [Solving Means] An information processing apparatus includes a mobile object control unit. When an intermediate object is determined to be situated between a user and a mobile object, the mobile object control unit controls the mobile object so that a relative positional relationship between the mobile object and the intermediate object as viewed from the user is changed, the mobile object having a movement mechanism, the user and the mobile object being in real space, the mobile object control unit controlling the mobile object on the basis of information regarding a visual line of the user that is acquired after the relative positional relationship is changed.

### TECHNICAL FIELD

The present technology relates to an information processing apparatus, an information processing method, and a program for a mobile object such as an autonomous action robot.

### BACKGROUND ART

It is described in Patent Literature 1 that an image of an imaginary object is superimposed on an optical image of a real object positioned in real space on the basis of an AR technology using an HMD (Head Mounted Display). It is described in Patent Literature 1 that an imaginary object is moved so as to actively guide the visual line of a user wearing a HMD, whereby any of a plurality of imaginary objects to which the user turns his/her eyes is specified as an operation target to make an interaction with the user suitable.

### CITATION LIST

### Patent Literature

Patent Literature 1: WO 2017/187708

### DISCLOSURE OF INVENTION

### Technical Problem

Nowadays, the realization of natural communication between mobile objects such as autonomous action robots and users has been desired. For the realization of natural communication, it is sometimes necessary to determine whether users are gazing mobile objects.

Note that there is a case that an intermediate object exists between a mobile object and a user when the mobile object is controlled. In this case, it may be falsely determined that the user is gazing the mobile object even if the user is actually gazing the intermediate object. The false determination possibly causes the mobile object to take action not intended by the user.

In view of the problem, the present disclosure provides an information processing apparatus, an information processing method, and a program that make it possible to properly determine whether a user is gazing a mobile object even if an intermediate object exists between the user and the mobile object.

### Solution to Problem

An information processing apparatus according to an embodiment of the present technology includes a mobile object control unit.

When an intermediate object is determined to be situated between a user and a mobile object, the mobile object control unit controls the mobile object so that a relative positional relationship between the mobile object and the intermediate object as viewed from the user is changed, the mobile object having a movement mechanism, the user and the mobile object being in real space, the mobile object control unit controlling the mobile object on the basis of information regarding a visual line of the user that is acquired after the relative positional relationship is changed.

According to such a configuration, a mobile object is controlled so that the relative positional relationship between the mobile object and an intermediate object as viewed from a user is changed. Therefore, a change in the visual line of the user is more easily detected when the relative positional relationship is changed. As a result, accuracy in determining whether the user is gazing the mobile object is improved. Accordingly, the action of the mobile object that is taken on the basis of a determination result becomes suitable for a situation, and the user can naturally communicate with the mobile object.

The mobile object control unit may control the mobile object so that the mobile object after the change in the relative positional relationship is located at a position other than a position in a direction of the visual line of the user at a time immediately before the relative positional relationship is changed.

According to such a configuration, a change in the visual line of a user is easily detected, and accuracy in determining whether the user is gazing a mobile object is improved.

For example, when a mobile object moves in the direction of a visual line as first action, the movement of the mobile object as viewed from a user is movement to a front side or movement to a back side. In this case, it is difficult to detect a change in the visual line of the user who follows the mobile object with his/her eyes. Accordingly, the mobile object is caused to move in a direction other than the direction of the visual line, whereby the change in the visual line of the user who follows the mobile object with the eyes is easily detected.

The mobile object control unit may control the mobile object so that the mobile object after the change in the relative positional relationship is located in an imaginary line orthogonal to the direction of the visual line.

According to such a configuration, a change in the visual line of a user is more easily detected, and accuracy in determining whether the user is gazing is improved.

There may exist a plurality of the users, and the mobile object control unit may control the mobile object so that the mobile object after the change in the relative positional relationship is located at a position other than positions in visual-line directions of the respective visual lines of the plurality of the users at the time immediately before the relative positional relationship is changed.

The mobile object control unit may control the mobile object so that action of the mobile object acting so that the relative positional relationship is changed, is not similar to action of the intermediate object, as viewed from the user.

According to such a configuration, a change in the visual line of a user is easily detected, and accuracy in determining whether the user is gazing is improved.

The mobile object control unit may control the mobile object so that the mobile object moves in a direction different from a movement direction of the intermediate object, as viewed from the user.

As described above, a mobile object may be caused to take action to move in a direction different from a movement direction of the intermediate object as action not similar to the action of the intermediate object.

The mobile object control unit may control the mobile object using a predicted position of the intermediate object that is predicted on the basis of a temporal change in information regarding a past position of the moving intermediate object.

According to such a configuration, even if the mobile object is an intermediate object, the prediction of action of the intermediate object makes it possible to cause the mobile object to take action by which a change in the visual line of a user is easily detected.

The mobile object control unit may control the mobile object so that the mobile object takes action different from action of the mobile object that is taken immediately before the relative positional relationship is changed and so that the relative positional relationship is changed.

According to such a configuration, a change in the visual line of a user is easily detected, and accuracy in determining whether the user is gazing a mobile object is improved.

The mobile object control unit may control the mobile object so that the mobile object moves in a movement direction different from a direction of movement of the mobile object that is performed immediately before the relative positional relationship is changed and so that the relative positional relationship is changed.

The mobile object control unit may control the mobile object so that the mobile object moves in a direction different by 180 degrees from the direction of the movement of the mobile object that is performed immediately before the relative positional relationship is changed and so that the relative positional relationship is changed.

According to such a configuration, it is possible to make a user easily follow a mobile object with his/her eyes and easily detect a change in the visual line of the user in a case in which the visual line of the user is not directed to the mobile object but the user is possibly looking at the mobile object, a case in which the estimation of imaginary lines from the directions of the respective visual lines of a plurality of users is difficult, a case in which a multiplicity of mobile objects exists and the estimation of action different from the action of the mobile objects is difficult, or the like.

The mobile object control unit may control the mobile object so that the mobile object moves at a speed that enables the user to follow the mobile object with an eye and so that the relative positional relationship is changed.

According to such a configuration, it is possible for a user to follow a mobile object with his/her eyes by natural eye motion.

The mobile object may be a mobile body having the movement mechanism.

The mobile body may be capable of moving on the ground.

The mobile body may be capable of flying.

The information processing apparatus may be the mobile object including the movement mechanism and the mobile object control unit.

The mobile object may include an indicator indicating that the mobile object is on standby for receiving an instruction from the user.

According to such a configuration, it is possible to urge a user to gaze a mobile object through an indicator.

The mobile object may include an image acquisition unit that acquires information regarding an image of a surrounding environment, and the mobile object control unit may control the mobile object on the basis of the information regarding the visual line of the user, the information regarding the visual line of the user being acquired using the information regarding the image.

The image acquisition unit may include a depth sensor.

Thus, it is possible to obtain information regarding the distance between a mobile object and each object as information regarding a surrounding environment and perform more accurate person detection, object detection, face detection, visual line detection, or the like from information regarding an image.

An information processing method according to an embodiment of the present technology includes controlling, when an intermediate object is determined to be situated between a user and a mobile object, the mobile object so that a relative positional relationship between the mobile object and the intermediate object as viewed from the user is changed, the mobile object having a movement mechanism, the user and the mobile object being in real space; and controlling the mobile object on the basis of information regarding a visual line of the user that is acquired after the relative positional relationship is changed.

A program according to an embodiment of the present technology causes an information processing apparatus to perform processing including controlling, when an intermediate object is determined to be situated between a user and a mobile object, the mobile object so that a relative positional relationship between the mobile object and the intermediate object as viewed from the user is changed, the mobile object having a movement mechanism, the user and the mobile object being in real space; and controlling the mobile object on the basis of information regarding a visual line of the user that is acquired after the relative positional relationship is changed.

### Advantageous Effects of Invention

As described above, the present technology makes it possible to realize the natural communication between a user and a mobile object that exist in real space. Note that an effect achieved by the present technology is not necessarily limited to the effect described here but may include any effect described in the present disclosure.

### BRIEF DESCRIPTION OF DRAWINGS

FIG. 1 is a view for describing a state in which an autonomous action robot acting as an information processing apparatus according to a first embodiment of the present technology is used.

FIG. 2 is a block diagram showing the configuration of the autonomous action robot.

FIG. 3 is a flowchart for describing an example of a gaze determination in the autonomous action robot.

FIG. 4 is a view (part 1) for describing first action for the gaze determination that is taken by the autonomous action robot.

FIG. 5 is a view (part 2) for describing the first action for the gaze determination that is taken by the autonomous action robot.

FIG. 6 is a view (part 3) for describing the first action for the gaze determination that is taken by the autonomous action robot.

FIG. 7 is a view (part 4) for describing the first action for the gaze determination that is taken by the autonomous action robot.

FIG. 8 is a view (part 5) for describing the first action for the gaze determination that is taken by the autonomous action robot.

FIG. 9 is a view for describing a method for calculating a second target position where the autonomous action robot reaches according to the first action at the time of the gaze determination.

FIG. 10 is a view for describing a method for calculating a time at which the autonomous action robot reaches the second target position according to the first action at the time of the gaze determination.

FIG. 11 is a view (part 1) for describing the first action for the gaze determination that is taken by the autonomous action robot when a mobile object exists around the autonomous action robot.

FIG. 12 is a view (part 2) for describing the first action for the gaze determination that is taken by the autonomous action robot when the mobile object exists around the autonomous action robot.

FIG. 13 is a view (part 3) for describing the first action for the gaze determination that is taken by the autonomous action robot when the mobile object exists around the autonomous action robot.

FIG. 14 is a view for describing the determination of the movement of the surrounding mobile object.

FIG. 15 is a view showing an example of the hardware configuration of the autonomous action robot.

FIG. 16 is a view for describing first action for a gaze determination that is taken by an autonomous action robot according to a second embodiment.

FIG. 17 is a view (part 1) for describing first action for a gaze determination that is taken by an autonomous action robot according to a third embodiment.

FIG. 18 is a view (part 2) for describing the first action for the gaze determination that is taken by the autonomous action robot according to the third embodiment.

FIG. 19 is a view (part 3) for describing the first action for the gaze determination that is taken by the autonomous action robot according to the third embodiment.

FIG. 20 is a view (part 4) for describing the first action for the gaze determination that is taken by the autonomous action robot according to the third embodiment.

### MODE(S) FOR CARRYING OUT THE INVENTION

### First Embodiment

(Schematic Configuration)

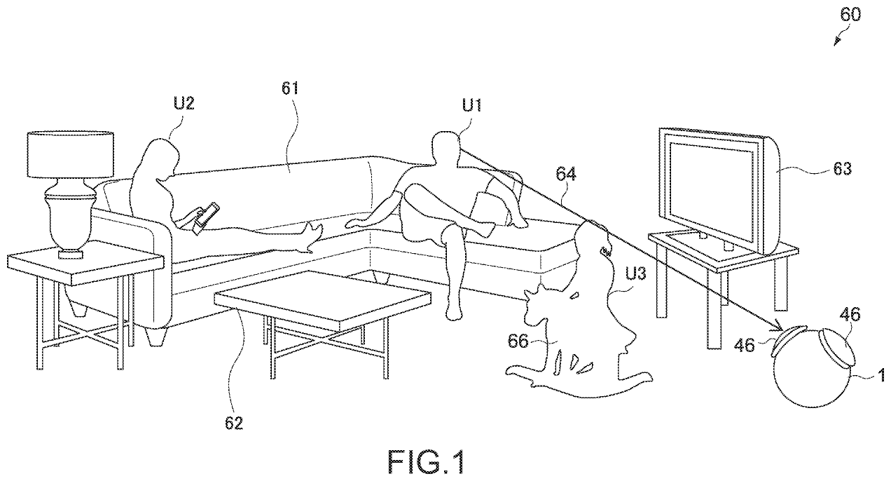

First, an information processing apparatus according to an embodiment of the present technology will be described with reference to FIG. 1. FIG. 1 is a view for describing a state in which an autonomous action robot acting as an information processing apparatus is used.

As shown in FIG. 1, users U1 to U3 and an autonomous action robot 1 acting as an information processing apparatus exist in, for example, a living room 60 that is real space. In the living room 60, a sofa 61, a table 62, and a TV set 63 that are stationary objects not often moved by users are arranged.

The autonomous action robot 1 (hereinafter simply called a robot) that is a mobile body acting as a mobile object is, for example, a robot that supports life as a human partner and places importance on communication with humans, and is a mobile object that exists in real space.

The robot 1 is configured to determine whether a user is gazing the robot 1 and is configured to take proper action for the user on the basis of a gaze determination result.

For example, when it is determined that a user is gazing the robot 1, the robot 1 can take any action for the user who is gazing the robot 1 and have natural communication with the user.

On the other hand, when it is determined that the user is not gazing the robot 1, the robot 1 continues to take action that has been taken immediately before the gaze determination, for example. Thus, the robot 1 is prevented from taking unnatural action for the user who is not gazing the robot 1. Further, when the robot 1 takes any action for the user although it is determined that the user is not gazing the robot 1, the robot 1 can take any action after calling attention to the user and have natural communication with the user.

Here, an autonomous action type robot in a spherical shape configured to be capable of autonomously traveling on the ground is exemplified as a mobile object, but the mobile object is not limited to such a robot. The mobile robot may be a mobile object including a movement mechanism capable of moving on the ground or in the air. Alternatively, the mobile robot may be a pet type robot imitating an animal such as a dog and a cat or a human type robot. Alternatively, the mobile robot may be a flying type robot configured to be capable of flying in the air.

(Configuration of Robot)

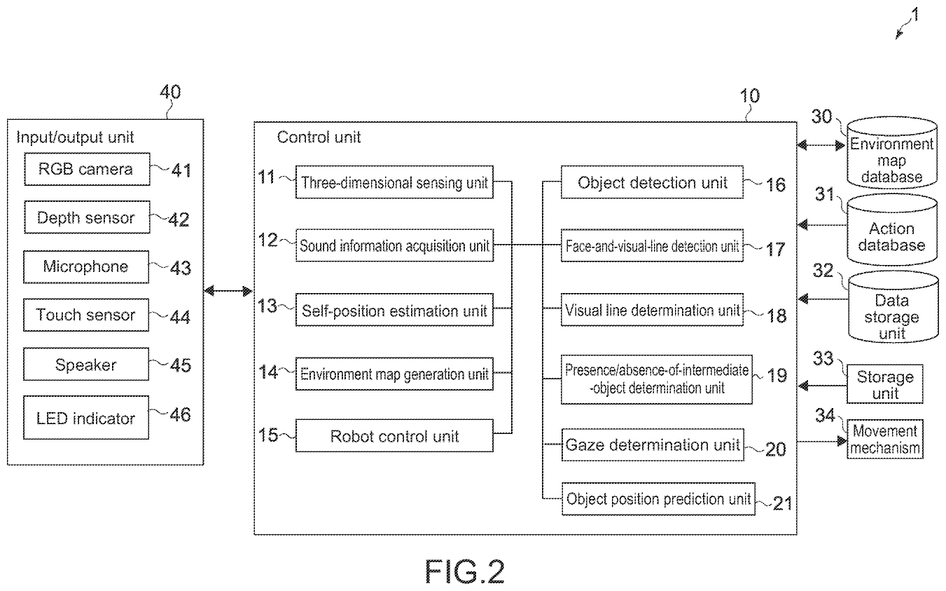

FIG. 2 is a block diagram showing the configuration of the robot 1 of the present embodiment.

As shown in FIG. 2, the robot 1 acting as an information processing apparatus has a control unit 10, an input/output unit 40, an environment map database 30, an action database 31, a data storage unit 32, a storage unit 33, and a movement mechanism 34.

The movement mechanism 34 is movement means for causing the robot 1 acting as a mobile object to move in real space under the control of a robot control unit 15 of the control unit 10 that will be described later.

Examples of the movement mechanism 34 include a leg type movement mechanism, a wheeled movement mechanism, a crawler type movement mechanism, and a propeller movement mechanism. A robot including the leg type movement mechanism, the wheeled movement mechanism, or the crawler type movement mechanism is capable of moving on the ground. A robot including the propeller movement mechanism is capable of flying and moving in the air.

The movement mechanism has a movement unit that causes the robot to move and driving means for driving the movement unit.

The leg type movement mechanism is used in, for example, a human type robot, a pet type robot, or the like. The leg type movement mechanism has leg units acting as movement units and actuators acting as driving means for driving the leg units.

For example, a pet type robot imitating a dog typically includes a head unit, a body unit, leg units (four legs), and a tail unit. Actuators are provided in the joints of the leg units (four legs), the connection parts between the respective leg units and the body unit, the connection parts between the head unit and the body unit, and the connection part between the tail unit and the body unit. The movement of the robot is controlled by the drive and the control of the respective actuators.

The wheeled movement mechanism has wheels acting as movement units and a motor acting as drive means for driving the wheels. By the rotation and the drive of wheels attached to the body of the robot 1, the body of the robot 1 is moved on a ground plane. In the present embodiment, the robot 1 including the wheeled movement mechanism will be exemplified.

The crawler type movement mechanism has crawlers acting as movement units and drive means for driving the crawlers. By the rotation and the drive of the crawlers attached to the body of the robot 1, the body of the robot 1 is moved on a ground plane.

The propeller movement mechanism has a propeller acting as a movement unit that moves a robot and an engine or a battery that acts as drive means for driving the propeller.

In the robot 1, the first action of the robot 1 is controlled on the basis of information regarding a surrounding environment that is acquired by various sensors constituting the input/output unit 40. The first action is action for gaze determination processing. The first action is controlled so that the relative positional relationship between the robot 1 and an intermediate object as viewed from a user is changed. The intermediate object is an object existing between the user and the robot 1 that exist in real space.

Then, the robot 1 is controlled to take second action on the basis of information regarding the visual line of the user that is acquired after the relative positional relationship is changed. Specifically, the gaze determination processing as to whether the user is gazing the robot 1 is performed according to a change in the visual line of the user during the execution of the first action of the robot 1 that is calculated on the basis of the information regarding the visual line of the user. The robot 1 is controlled to take the second action on the basis of a gaze determination result.

The input/output unit 40 has a camera (imaging device) 41, a depth sensor 42, a microphone 43, and a touch sensor 44 that constitute an input unit, and a speaker 45 and a LED (Light Emitting Diode) indicator 46 that constitute an output unit. Note that the camera 41 may include various imaging devices such as an RGB camera, a monochrome camera, an infrared camera, a polarization camera, and an event-based camera. Note that the event-based camera is a camera that outputs an image only when a change in brightness or the like occurs between images.

The camera 41 acting as an image acquisition unit is a camera that shoots surrounding real space. The camera 41 acquires RGB images, monochrome images, infrared images, polarization images, differential images, or the like depending on the type of an image sensor. Image information acquired as a shooting result is supplied to the control unit 10. The camera 41 may be in a singular or plural form. The camera 41 is installed at, for example, the top of the robot 1.

The depth sensor 42 acting as an image acquisition unit acquires information regarding the distance between the depth sensor 42 and an object. The acquired three-dimensional distance image information is supplied to the control unit 10. The depth sensor 42 is installed at, for example the top of the robot 1.

The object includes not only persons such as users but also objects other than the persons. The persons are mobile objects capable of moving.

The objects other than the persons includes not only stationary objects such as the sofa 61, the table 62, and the TV set 63 not often moved by users and fixed in real space but also mobile objects other than the persons.

Examples of the mobile objects other than the persons include animals such as dogs and cats, cleaning robots, and typically small objects such as plastic bottles and cups easily moved by users.

As the depth sensor 42, a publicly-known sensor may be used. For example, a method in which infrared rays or the like are applied and a distance to an object is measured according to a time until the reflected light of the applied infrared rays is returned, a method in which a pattern is applied by infrared rays or the like and a distance to an object is measured according to the distortion of the pattern reflected on the object, a method in which images captured by a stereo camera are matched to each other and a distance to an object is measured according to the parallax between the images, or the like may be used.

The microphone 43 collects surrounding sound. Information on the collected sound is supplied to the control unit 10.

The touch sensor 44 detects contact with the robot 1 by a user. Information on the detected contact is supplied to the control unit 10.

The speaker 45 outputs a sound signal that is a robot control signal received from the control unit 10.

In the LED indicator 46 acting as an indicator, the lighting of an LED is controlled on the basis of a light emission signal that is a robot control signal received from the control unit 10. The LED indicator 46 forms emotions or the like of a robot through the combination of the blinking patterns or the lighting timing of the LED and notifies a user U of the condition of the robot 1.

For example, when taking any action for the user U, the robot 1 is capable of letting the user know the situation that the robot 1 is turning an eye to the user by lighting up a part of the LED indicator 46.

Further, the robot 1 is capable of presenting emotions such as delight, anger, sorrow, and pleasure to the user by changing a lit color.

Further, while being on standby for receiving instructions from the user, the robot 1 is capable of letting the user know the situation that the robot 1 is on standby for receiving the instructions by blinking the LED indicator 46.

The LED indicator 46 may be provided in the whole area or a part of the spherical robot 1. In the present embodiment, the robot 1 includes two LED indicators 46 in a part of its surface as shown in FIG. 1.

The robot 1 may also include a display such as an LCD (Liquid Crystal Display) that displays an image as an output unit. Thus, the robot 1 is capable of presenting information such as the emotions and the situations of the robot to the user through desired image display.

The control unit 10 controls a series of processing relating to a gaze determination.

The control unit 10 may include a three-dimensional sensing unit 11, a sound information acquisition unit 12, a self-position estimation unit 13, an environment map generation unit 14, a robot control unit 15 acting as a mobile object control unit, an object detection unit 16, a face-and-visual-line detection unit 17, a visual line determination unit 18, a presence/absence-of-intermediate-object determination unit 19, a gaze determination unit 20, and an object position prediction unit 21.

The three-dimensional sensing unit 11 integrates image information acquired by the camera 41 and three-dimensional distance image information acquired by the depth sensor 42 with each other to construct a surrounding environment three-dimensional shape.

The surrounding environment three-dimensional shape may be constructed in such a manner that three-dimensional coordinates are output as a point group by a three-dimensional scanner using a laser.

The sound information acquisition unit 12 acquires sound information collected by the microphone 43.

The self-position estimation unit 13 estimates the self-position of the robot 1 in which the camera 41 and the depth sensor 42 are installed, by identifying the feature points of the appearance of an object that are stored in the data storage unit 32 that will be described later with the three-dimensional coordinates of the feature points of the object that are extracted from a three-dimensional shape constructed by the three-dimensional sensing unit 11. That is, the self-position estimation unit 13 estimates the position of the living room 60 at which the robot 1 exists.

Further, a sensor other than a camera such as an IMU (Inertial Measurement Unit) and a GPS (Global Positioning System) may be provided, besides a camera and a depth sensor, and their sensor information may be integrated with each other to perform more accurate self-position estimation.

The object detection unit 16 detects the regions of persons and the regions of objects other than the persons from a three-dimensional shape constructed by the three-dimensional sensing unit 11.

As a method for detecting the regions of the persons, a recognition method based on HOG (Histograms of Oriented Gradients) feature amounts and a SVM (Support Vector machine) using image information, a recognition method using a convolutional neural network, or the like may be used.

Further, more accurate detection may be performed by detecting the persons using three-dimensional distance image information, besides the image information.

A method for detecting the regions of the objects other than the persons may include detecting unknown objects from a three-dimensional shape and classifying the detected objects using shape information to recognize the objects.

Further, an object recognition technology based on shape feature amounts may be used to perform classification with the assumption that object shapes which are detection targets are known shapes. In this manner, more accurate object detection may be performed.

The environment map generation unit 14 generates an environment map expressing the position of the robot 1, the positions of respective objects, or the like that exist in real space on the basis of a three-dimensional shape constructed by the three-dimensional sensing unit 11, the estimated position of the robot 1 estimated by the self-position estimation unit 13, and the regions of persons and the regions of objects other than the persons that are detected by the object detection unit 16.

The environment map generation unit 14 generates an environment map expressing the positions of the robot 1, persons, and objects other than the persons every certain time. The generated environment map is accumulated in the environment map database 30 in a time series.

The estimation of the self-position of the robot 1 and the generation of an environment map may be performed at the same time using a technology called visual SLAM (Simultaneous Localization and Mapping).

Further, in the environment map database 30, an environment map acting as answer data may be registered in advance.

By referring to the environment map of answer data and a three-dimensional shape constructed by the three-dimensional sensing unit 11, the self-position of the robot 1 may be estimated.

Further, for example, an environment map expressing real space in which mobile objects do not exist but only stationary objects exist may be registered in advance in the environment map database 30 as answer data. On the basis of a difference in the background between the environment map of the answer data and a three-dimensional shape constructed by the three-dimensional sensing unit 11, the regions of persons and the regions of mobile objects other than the persons may be detected.

The face-and-visual-line detection unit 17 detects the regions of faces from the regions of persons that are output from the object detection unit 16 and detects the directions of the faces and the visual lines of the persons.

For the detection of the regions of faces, a publicly known method using the image feature amounts (Facial Appearance) of image information may be used. In addition, three-dimensional distance image information may be used, besides the image information to perform more accurate detection.

For the detection of the directions of faces, a publicly known method may be used. For example, the directions of noses or the directions of jaws may be detected to detect the directions of the faces.

For the detection of visual lines, a publicly known method may be used. For example, the visual lines of persons may be detected from the distances between the inner corners of eyes and the centers of black eyes using image information.

Further, a corneal reflex method may be used in which visual lines are detected using infrared light. According to the corneal reflex method, images of the portions of the eyes of a user are shot with the application of infrared light, and the direction of visual lines is detectable from the reflected positions of the infrared light on the corneal of the eyes of the user who is a detection target, that is, from the positional relationship between the luminous spots of the infrared light and the pupils of the user who is the detection target in images obtained by the shooting.

The visual line determination unit 18 determines whether any person detected from a three-dimensional shape is turning his/her face to the robot 1 or the visual line of the person is directed to the robot 1, on the basis of a result of detection performed by the face-and-visual-line detection unit 17.

The presence/absence-of-intermediate-object determination unit 19 determines, using an environment map, whether any object exists between the robot 1 and a person (user) who becomes a gaze determination target for which a determination is made as to whether the person is gazing the robot 1.

An intermediate object represents an object positioned between a person who becomes a gaze determination target and the robot 1. The present embodiment exemplifies a case in which the intermediate object is a real object existing in real space. The intermediate object may be a person or an object other than the person. Further, the intermediate object may be a stationary object or a mobile object.

The gaze determination unit 20 determines whether a person (hereinafter called a target person in some cases) who becomes a gaze determination target is gazing the robot 1.

The robot 1 takes first action for a gaze determination under the control of the robot control unit 15 that will be described later. The gaze determination unit 20 determines whether the target person is gazing the robot 1 on the basis of a change in the visual line of the target person during the first action of the robot 1, that is, during a period from the start to the end of the first action.

When the target person is gazing the robot 1, the eye motion of the user follows the movement of the robot 1.

In the present embodiment, the gaze determination unit 20 acquires information regarding the visual line of the target person during a period from the start to the end of the first action of the robot 1 from the face-and-visual-line detection unit 17 in a time series, and then calculates a change in the visual line of the target person, that is, the track of the visual line on the basis of the acquired information regarding the visual line.

The gaze determination unit 20 determines the presence or absence of the correlation between the movement track of the robot 1 and the track of the visual line of the target person on the basis of the movement track of the robot 1 during a period from the start to the end of the first action, the calculated track of the visual line of the target person, and information regarding the distance between the target person and the robot 1 that is acquired from the depth sensor 42 to determine whether the target person is gazing the robot 1.

When determining that the correlation is present, the gaze determination unit 20 determines that the target person is gazing the robot 1. On the other hand, when determining that the correlation is absent, the gaze determination unit 20 determines that the target person is not gazing the robot 1.

The object position prediction unit 21 predicts the positions of respective objects after current time from changes in information regarding the past positions of mobile objects including persons obtained on the basis of an environment map accumulated in a time series.

The robot control unit 15 controls first action taken by the robot 1 for a gaze determination and second action taken by the robot 1 on the basis of a gaze determination result. A control signal that is generated by the robot control unit 15 and relates to the action of the robot 1 will be called a robot control signal.

The first action is an action taken by the robot 1 to determine whether a target person is gazing the robot 1.

The second action is taken by the robot 1 on the basis of a change in the visual line of the target person during the first action that is calculated using information regarding the visual line of the target person that is acquired after the first action is taken. The change in the visual line is detected by the gaze determination unit 20 described above. Further, the second action is taken by the robot 1 on the basis of information regarding the visual line of the target person that is acquired after the first action is taken.

The robot control signal includes the control signal of the movement mechanism 34 that relates to the action of the robot 1, the light emission signal of the LED indicator 46 that relates to the notification of the emotions, the situations, or the like of the robot 1, a sound signal that relates to sound produced from the robot 1 and is supplied to the speaker 45, or the like.

When it is determined by the presence/absence-of-intermediate-object determination unit 19 that an intermediate object is absent, the robot control unit 15 generates a robot control signal relating to first action for a gaze determination according to prescribed processing that will be described later.

When it is determined by the presence/absence-of-intermediate-object determination unit 19 that the intermediate object is present, the robot control unit 15 generates the robot control signal relating to the first action so that the relative positional relationship between the robot 1 acting as a mobile object and the intermediate object as viewed from a target user is changed.

In addition, when the intermediate object is a mobile object, the robot control unit 15 generates the robot control signal relating to the first action with consideration given to the position of the intermediate object that is predicted by the object position prediction unit 21.

In the example shown in FIG. 1, the user U3 exists between the user U1 and the robot 1 as an intermediate object.

In such a situation, it is difficult to determine whether the user U1 is gazing one of the robot 1 and the user U3 or the user U1 is not gazing both the robot 1 and the user U3 on the basis of information regarding the visual line of the user U1 even if the face of the user U1 is directed to the robot 1.

Therefore, in order to determine whether the user U1 is gazing the robot 1, the robot 1 takes first action so that the relative positional relationship between the robot 1 and the user U3 as viewed from the user U1 is changed.

Then, by detecting how the visual line of the user U3 is changed according to the first action taken by the robot 1, the robot 1 determines whether the user U1 is gazing the robot 1.

In the present embodiment, the first action of the robot 1 is basically action different from the action of the robot 1 at a time immediately before the first action is taken. A second target position that is a position where the robot 1 reaches according to the first action is a position other than a position in the direction of the visual line of a user (target person). The first action is controlled at a speed at which a difference in the angle of the visual line of the user (target person) who follows the robot 1 with his/her eyes becomes within 30 degrees per second.

Note that the time immediately before the first action is taken here represents a time immediately before the relative positional relationship between the robot and an intermediate object as viewed from the user is changed. Further, a time at which the robot reaches the second target position according to the first action is a time immediately after the first action is taken and represents a time after the relative positional relationship is changed.

In addition, the first action of the robot 1 is controlled in a range in which the robot 1 does not collide with objects including persons or walls around the robot 1, and controlled so that the robot 1 moves to space in which the objects do not exist to a greater extent.

The details of a method for generating basic first action will be described as a method for generating prescribed first action below.

Here, as a position other than a position in the direction of the visual line of a user (target person), a position in an imaginary line orthogonal to the direction of the visual line of the user is exemplified. The imaginary line (for example, a line denoted by symbol L in FIGS. 7 to 10) passes through the robot 1, is substantially parallel to the ground plane of the robot 1, and is set at a height position near the installation position of the camera 41 or the depth sensor 42 that is installed in the robot 1. The camera 41 or the depth sensor 42 plays a role as an “eye” in the robot 1, and the imaginary line L is set at a height position corresponding to the eye line of the robot 1.

Since the first action is controlled to be different from the previous action of the robot 1, it is easy to detect a change in the visual line of a target person with respect to the movement path of the robot. Further, since the robot 1 is controlled to take action different from previous action, a target person may be urged to pay attention to the robot 1 to move the direction of his/her visual line. Thus, accuracy in the gaze determination processing may be further improved.

In the present embodiment, the robot 1 takes action to move in a direction different from a traveling direction in previous action as action different from action previous to the first action.

The action different from the previous action is desirably action by which attention from a user is easily directed to the robot 1. Thus, it is easy to determine whether the robot 1 is just randomly moving or the robot is moving in order to receive instructions from the user.

As another example of the action different from the action previous to the first action, the LED indicator 46 that has not been lit in the previous action may be lit in the first action.

In addition, as another example, the robot may move while rotating as the action different from the previous action.

Further, if a mobile object is a pet type robot imitating a dog, the robot may move while swinging a tail as the action different from the previous action.

Further, since the first action is controlled to move in a direction orthogonal to the direction of the visual line of a target person at a time immediately before the first action is taken, a change in the visual line of the target person increases.

For example, when the robot 1 moves in the direction of the visual line of the target person, i.e., when the robot 1 moves on the vector of the visual line of the target person and on the extension of the vector of the visual line, the movement of the robot 1 as viewed from the target person is movement to a front side or movement to a back side. Since the visual line of the user who follows the robot 1 with his/her eyes does not change largely in this case, it is difficult to make a gaze determination. Here, the vector of the visual line represents a directed segment directed from the eyes of the target person to the robot 1 and represents information regarding the visual line of the target person.

Accordingly, when the user is gazing the robot 1, a second target position where the robot 1 reaches according to the first action is set in an imaginary line orthogonal to the vector of the visual line of the target person and the robot 1 is moved to the second target position. In this manner, since a change in the visual line of the target person increases, it is easy to detect the change in the visual line. Thus, accuracy in the gaze determination processing may be further improved.

Note that the second target position may not be necessarily set in the imaginary line orthogonal to the direction of the visual line of the target person and is not desirably set in the direction of the visual line.

When the second target position is set at a position other than a position in the direction of the visual line of the target person as described above, an intermediate object nearly positioned on the visual line of the target person deviates from the visual line of the target person. Therefore, it is easy to determine whether the visual line of the target person is directed to the intermediate object or the robot 1.

Further, since the first action is controlled at the speed at which a difference in the angle of the visual line of the target person becomes within 30 degrees per second, it is possible for the target person to follow the movement of the robot 1 with his/her eyes by natural eye motion.

In addition, when the intermediate object exists between the target person and the robot 1, the first action of the robot 1 is controlled so that the relative positional relationship between the robot 1 and the intermediate object as viewed from the target person is changed regardless of whether the intermediate object moves or not.

Further, when the intermediate object is a mobile object, the first action of the robot 1 is desirably controlled so as not to be similar to the action of the intermediate object. Thus, accuracy in gaze determination is improved.

Here, as shown in FIG. 1, a case in which the user U1 acting as a target person sits on the sofa 61 and remains stationary and the robot 1 takes the first action to move is exemplified. However, when the target person is in motion, the robot 1 may take the first action to be put in a stationary state so that the relative positional relationship between the robot 1 and an intermediate object as viewed from the target person is changed.

The second action of the robot 1 is action taken by the robot 1 for a target person using the action database 31 on the basis of a gaze determination result and a surrounding situation. The surrounding situation includes action information or state information regarding the target person, and such information may be acquired from information regarding the visual line or the like of the target person.

The action information is information relating to action such as reading a book, watching a TV program, and listening to music.

The state information is information relating to a state such as a user's laughing state, a sorrowful state, and a bustling state.

For example, the action information may be acquired in such a manner that feature points are extracted from image information acquired from the camera 41 and the extracted feature points are tracked to recognize the action of a person (action recognition processing).

For example, the state information may be acquired in such a manner that the motion of eyes or eyebrows is analyzed from image information acquired by the camera 41, the tone of voice is analyzed from sound information acquired by the microphone 43, or both of these analysis results are used to recognize a user's laughing state, a sorrowful state, a bustling state, or the like (state recognition processing). Further, user's speech content may be recognized from sound information acquired by the microphone 43. Thus, a user's state may be recognized.

As an example of the second action, the robot 1 takes any action for the user such as getting close to the user, lighting the LED indicator 46 to express joy, and producing sound such as playing music on the basis of the action database 31 when it is determined by a gaze determination that the user is gazing the robot 1.

On the other hand, as an example of the second action, the robot takes action to move to a first target position immediately before the gaze determination when it is determined by the gaze determination that the user is not gazing the robot 1. Alternatively, the robot 1 may take action according to a surrounding situation. For example, when the robot 1 has received or has had information needed to be notified to a user such as an incoming e-mail, the robot 1 may take the second action to call attention to the user such as getting close to the user and producing sound from the speaker 45, besides notifying the user of the incoming e-mail through the lighting of the LED indicator 46.

Note that the action example is not limited to such examples.

The environment map database 30 accumulates in a time series an environment map expressing information regarding objects such as the positions and the shapes of objects other than persons recognized in a room such as the sofa 61, the table 62, and the TV set 63, space information such as the positions of walls, and information regarding persons such as users.

By following changes in the positions of persons and mobile objects other than the persons on the basis of environment maps accumulated in a time series in the environment map database 30, movement information such as the movement tracks of the persons and the mobile objects other than the persons may be acquired.

The action database 31 stores various action content prescription files such as a motion file for each action in which an action model prescribing action to be taken by the robot 1 in any surrounding situation and the movement of the movement mechanism 34 of the robot 1 to cause the robot 1 to take the action are prescribed, a sound file in which the sound signal of sound to be produced by the robot 1 at that time is stored, and a file in which a light emission signal relating to light emission presented by the LED indicator 46 is stored.

The respective databases are constructed in the robot 1 acting as an information processing apparatus in the present embodiment but may be constructed on a cloud server.

When the databases are constructed on a cloud server, various information acquired by the input/output unit 40 is converted into information excluding privacy so as to make users, addresses of homes, or the like not identifiable and then transmitted to the could server.

The data storage unit 32 stores information such as the feature points and the feature amounts of the appearances of objects used when self-position estimation or the detection of persons or objects is performed.

The storage unit 33 includes a memory device such as a RAM and a non-volatile recording medium such as a hard disk drive and stores a program for causing the robot 1 acting as an information processing apparatus to perform a series of information processing relating to a gaze determination that will be next described.

(Information Processing Method Relating to Gaze Determination)

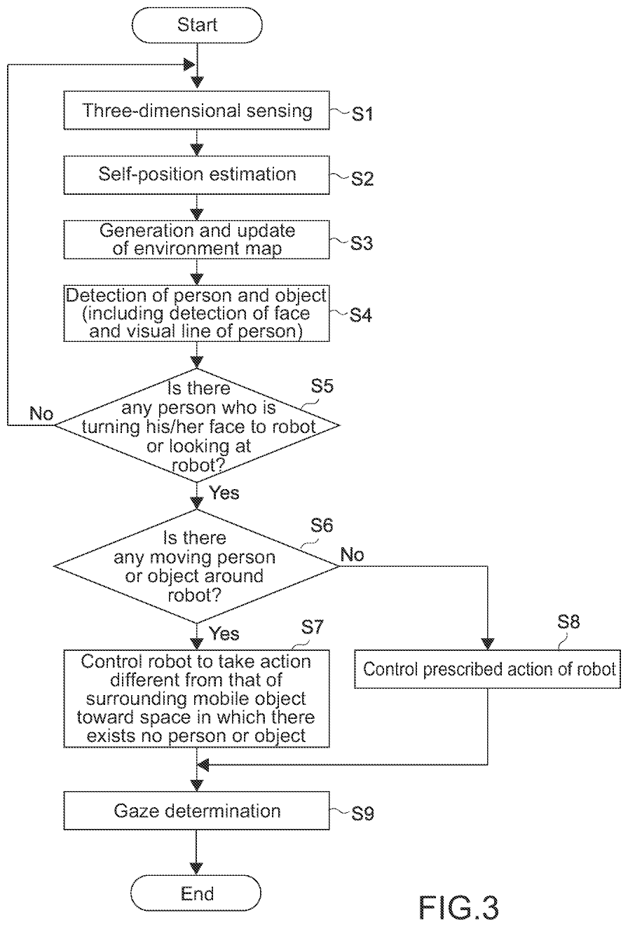

FIG. 3 is a flowchart of an information processing method relating to a gaze determination performed by the robot 1 acting as an information processing apparatus.

First, when gaze determination processing starts, a surrounding environment three-dimensional shape is constructed by the three-dimensional sensing unit 11 (S1).

Next, the position of the robot 1 is estimated by the self-position estimation unit 13 using the surrounding environment three-dimensional shape (S2), and an environment map is generated by the environment map generation unit 14 (S3).

Next, the regions of persons and the regions of objects other than the persons are detected by the object detection unit 16 on the basis of the environment map. In addition, the regions of faces are detected from the detected regions of the persons by the face-and-visual-line detection unit 17, and the directions of the faces and the visual lines of the persons are detected by the face-and-visual-line detection unit 17 (S4).

In the example shown in FIG. 1, the regions of the users U1, U2, and U3 are detected as the regions of the persons, and the regions of the sofa 61, the TV set 63, the table 62, and a rocking horse 66 are detected as the regions of the objects other than the persons.

Further, the directions of the faces and the visual lines of the persons are detected in all the extracted regions of the persons U1 to U3.

Next, on the basis of results of the detection performed by the face-and-visual-line detection unit 17, the detection being detection of the directions of the faces and the visual lines of the respective persons, it is determined, by the visual line determination unit 18, whether there is any person who is estimated to be turning his/her face to the robot 1 or to be directing his/her visual line to the robot 1, that is, whether there is any person who is estimated to be looking at the robot 1 (S5).

When it is determined in S5 that there does not exist such a person (No), the processing returns to S1 and is repeatedly performed.

When it is determined in S5 that there exists such a person (Yes), the processing proceeds to S6. In the example shown in FIG. 1, it is estimated from the detected visual line of the user U1 that the user U1 is looking at the robot 1. Therefore, the user U1 becomes a target person for the gaze determination processing.

In S6, it is determined, by the presence/absence-of-intermediate-object determination unit 19, whether any intermediate object exists between the person (target person) estimated to be looking at the robot 1 and the robot 1.

When it is determined in S6 that there exists no intermediate object (No), the processing proceeds to S8.

When it is determined in S6 that there exists an intermediate object (Yes), the processing proceeds to S7.

In the example shown in FIG. 1, the user U3 riding on the rocking horse 66 exists between the robot 1 and the user U1 as an intermediate object.

In S8, a robot control signal relating to first action taken to determine whether the user is gazing the robot 1 is generated by the robot control unit 15. The robot 1 is controlled on the basis of the robot control signal and takes the first action.

When there exists no intermediate object, the robot 1 is controlled so that the prescribed first action is taken. A method for generating the prescribed first action will be described later.

In S7, the robot control signal relating to the first action taken to determine whether the user who is a gaze determination target is gazing the robot 1 is generated by the robot control unit 15. The robot 1 is controlled on the basis of the robot control signal and takes the first action.

Specifically, in S7, when there exists an intermediate object, the robot control signal relating to the first action of the robot 1 is generated by the robot control unit 15 so that the relative positional relationship between the robot 1 and the user U3 riding on the rocking horse 66 as viewed from the user U1 who is a target person is changed. A method for generating the first action when there exists an intermediate object will be described later.

Next, the direction of the face and the visual line of the target person (here, the user U1) during a time from the start to the end of the first action are detected as occasion demands by the face-and-visual-line detection unit 17. By the gaze determination unit 20, a change in the visual line of the target person during the first action is calculated on the basis of time-series visual line detection results, and a determination is made as to whether the person who is a gaze determination target is gazing the robot 1 (S9).

In the manner described above, the gaze determination is performed.

When it is determined in the gaze determination step (S9) that the target person is gazing the robot 1, a robot control signal relating to second action to take any action for the target person is generated by the robot control unit 15 and the second action of the robot 1 is controlled on the basis of the robot control signal.

On the other hand, when it is determined in the gaze determination step (S9) that the person who is a gaze determination target is not gazing the robot 1, the robot 1 is controlled by the robot control unit 15 to take the second action to move to the first target position of action taken immediately before the gaze determination processing.

(Example of Method for Generating Prescribed First Action for Gaze Determination)

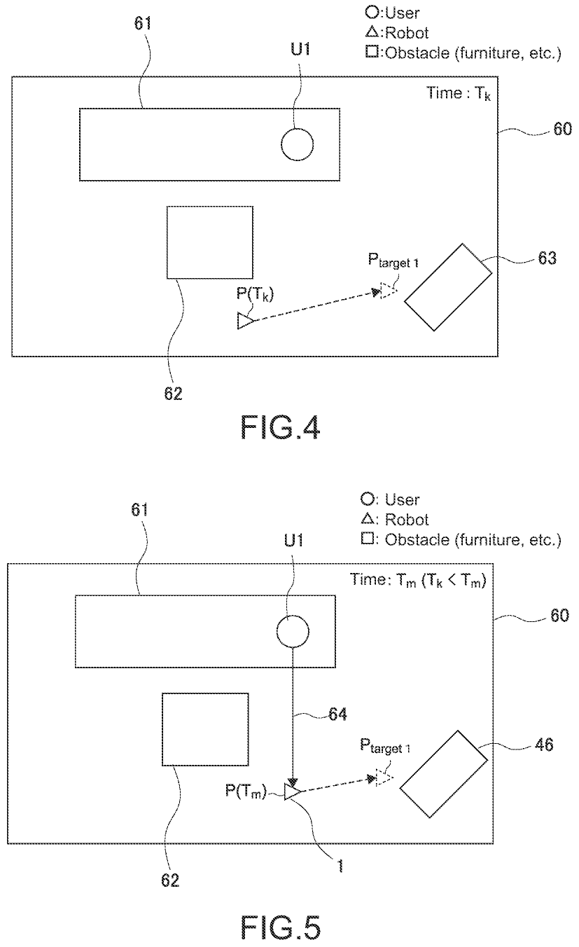

Next, an example of a method for generating the prescribed first action of the robot 1 that is controlled in S8 of the above gaze determination processing will be described using FIGS. 4 to 10.

FIGS. 4 to 10 are views for describing first action. FIGS. 4 to 8 are schematic views of the living room 60 that is real space as viewed from above. In the figures, a circle represents the user U, squares represent obstacles such as fixed stationary objects other than persons like the sofa 61, the table 62, and the TV set 63, and a triangle represents the robot 1.

FIG. 4 shows a state in which the robot 1 is located at a position P(Tₖ) at time Tₖ and is moving to a first target position P_{target1}.

Next, as shown in FIG. 5, a visual line 64 is detected by the face-and-visual-line detection unit 17 at a position P(Tₘ) at time Tₘ (Tₖ<Tₘ) during the movement of the robot 1 to the first target position P_{target1}. The visual line 64 is the visual line of the user U1 at a time immediately before the first action starts.

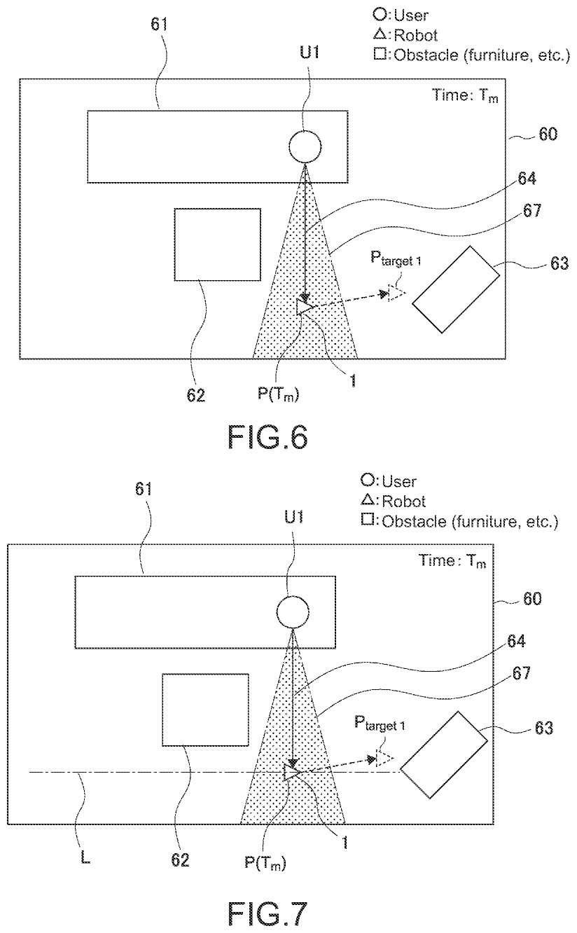

When it is determined by the visual line determination unit 18 that the visual line 64 of the user U1 is directed to the robot 1, a region 67 in which the user U1 can naturally follow the robot 1 with his/her eyes is estimated by the robot control unit 15 on the basis of information regarding the distance between the robot 1 and the user U1 that is measured by the depth sensor 42 and the vector (information regarding the visual line) of the visual line 64 as shown in FIG. 6.

In FIG. 6, the region 67 in which the user U1 can follow the robot 1 with the eyes is represented by a dot pattern. The region 67 is set to fall within a range in which a difference in the angle of the visual line of a target person who follows the robot 1 with his/her eyes becomes within 30 degrees per second.

Next, as shown in FIG. 7, the imaginary line L extending in a direction orthogonal to the vector of the visual line 64 is calculated by the robot control unit 15.

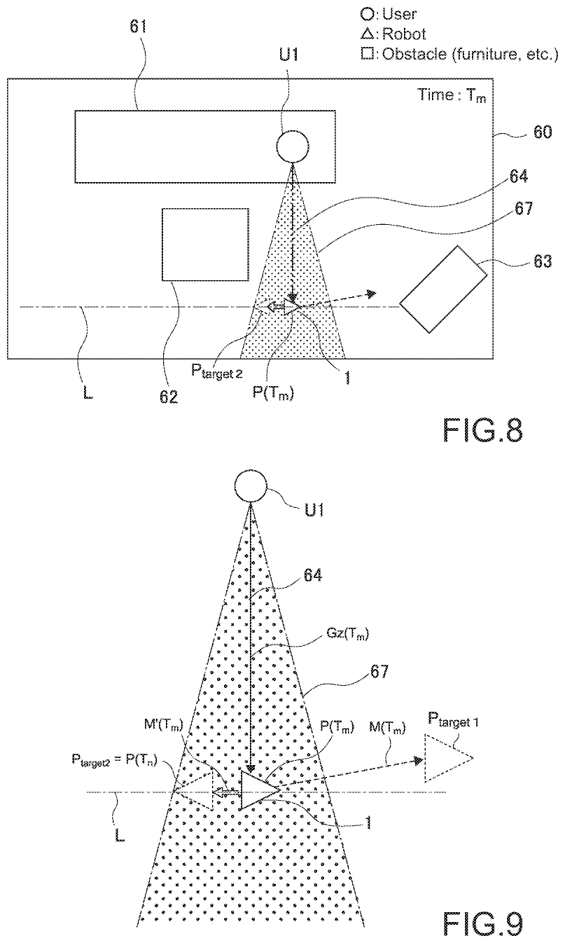

Next, as shown in FIG. 8, a second target position P_{target2} is set by the robot control unit 15 so that the second target position P_{target2} is located in the region 67 in which the user U1 can follow the robot 1 with the eyes and placed in the imaginary line L, and the movement direction of the first action becomes different from a movement direction from the position P(Tₘ) to the first target position P_{target1} that is a movement direction at the time immediately before the first action.

Next, the robot control signal of the first action taken by the robot 1 to reach the second target position P_{target2} at time Tₙ from the position P(Tₘ) is generated by the robot control unit 15. The second target position P_{target2} is the same as a position P(Tₙ) at which the robot 1 is located at the time Tₙ.

The robot 1 moves so as to reach the second target position P_{target2} at the time Tₙ according to the generated robot control signal of the first action. The robot control unit 15 calculates a change in the visual line of the user during the first action on the basis of information regarding the visual line of the target person that is detected by the visual line determination unit 18 during a period until the robot 1 reaches the second target position P_{target2} after departing from the position P(Tₘ), and determines whether the target person is gazing the robot 1.

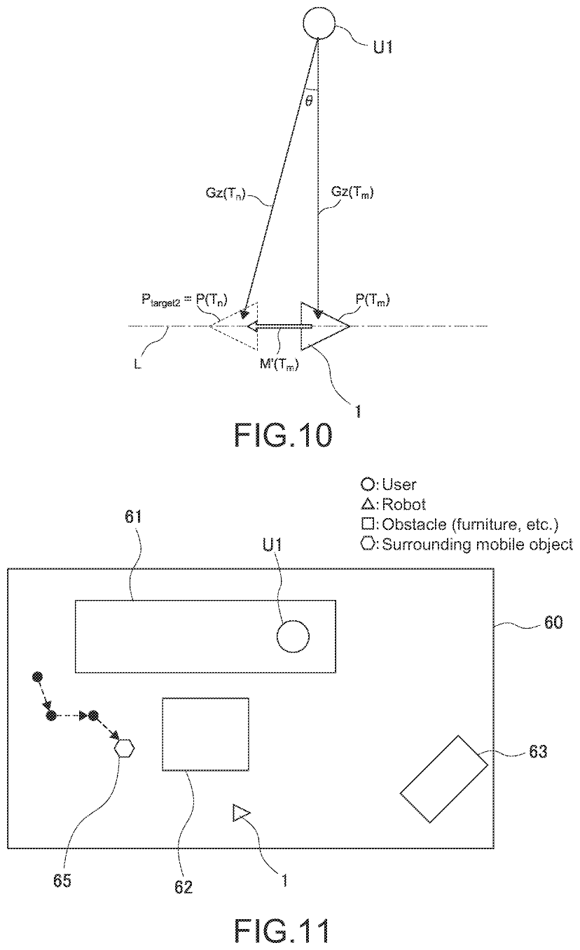

A method for calculating the second target position P_{target2} prescribing the first action to perform the gaze determination processing will be described using FIG. 9. A method for calculating a time at which the robot 1 reaches the second target position P_{target2} will be described using FIG. 10.

In the figures, the position of the robot 1 at the time Tₘ is represented by P(Tₘ), a motion vector directed from the position P(Tₘ) of the robot 1 to the first target position P_{target1} is represented by M(Tₘ), and the visual line vector of the visual line 64 is represented by Gz(Tₘ). The motion vector of the robot 1 directed from the position P(Tₘ) to the second target position P_{target2} is represented by M′(Tₘ). A time at which the robot 1 reaches the second target position P_{target2} is represented by Tₙ(Tₙ>Tₘ).

As shown in FIG. 9, a position that is located in the region 67 in which the user U1 can follow the robot 1 with the eyes, placed in the imaginary line L orthogonal to the visual line vector Gz(Tₘ), and is a position at which an angle formed by the motion vector M(Tₘ) and the motion vector M′(Tₘ) becomes maximum is calculated as the second target position P_{target2}.

In FIG. 10, an angle formed by a predicted vector Gz(Tₙ) of a visual line obtained when the user U1 looks at the second target position P_{target2} and the vector Gz (Tₘ) of a visual line obtained when the user U1 looks at the position P(Tₘ) is represented by θ.

As shown in FIG. 10, a velocity vector δP(Tₙ) of the robot 1 directed from the position P(Tₘ) to the second target position P_{target2} is expressed by Mathematical Formula 1.

$$δ P ( T n ) = \frac{{P}_{target 2} - P ( {T}_{m} )}{{T}_{n} - {T}_{m}} \qquad [ Math . 1 ]$$

An angular velocity δθ(Tₙ) of the visual line vector of the robot 1 directed from the position P(Tₘ) to the second target position P_{target2} is expressed by Mathematical Formula 2.

$$δ θ ( {T}_{n} ) = \frac{δ P ( {T}_{n} )}{\vert {G}_{z} ( {T}_{m} ) \vert} \qquad [ Math . 2 ]$$

With consideration given to the followability of the eye motion of a human, the time Tₙ is calculated so as to satisfy Mathematical Formula 3, whereby the time at which the robot 1 reaches the second target position P_{target2} may be calculated.

δθ(Tₙ)≤15 [deg/sec] [Math. 3]

Note that if it is predicted that the robot 1 collides with an object or a wall when moving on a calculated movement path from the current position P(Tₘ) to the second target position P_{target2} during a period from the time Tₘ to the time Tₙ, the second target position P_{target2} is set so that the movement direction of the first action becomes different from a movement direction at a time immediately before the first action in the region 67 in which the user U1 can follow the robot 1 with the eyes and within a range in which the robot 1 does not collide with an object or a wall during the first action.

(Example of Method for Generating First Action for Gaze Determination when Intermediate Object Exists)

When an intermediate object exists between a target person and the robot 1, first action is action different from the action of the robot 1 at a time immediately before the first action is taken and a second target position prescribing the first action and a time at which the robot 1 reaches the second target position are set so that the relative positional relationship between the robot 1 and the intermediate object as viewed from the target person is changed within a range in which the robot 1 does not collide with an object or a wall and in the region 67 in which the target person can follow the robot 1 with his/her eyes. The intermediate object may or may not move.

Specifically, when the target person is put in a stationary state and the intermediate object is a stationary object, the first action is controlled to be the above prescribed first action so that the relative positional relationship between the robot 1 and the intermediate object as viewed from the target person is changed.

When the target person is put in a stationary state and the intermediate object moves, a second target position P_{target2} prescribing the first action is set as follows so that the relative positional relationship between the robot 1 and the intermediate object as viewed from the target person is changed.

That is, the position of the intermediate object at time Tₙ after current time Tₘ is predicted by the object position prediction unit 21 on the basis of information regarding the past time-series position of the intermediate object obtained from an environment map accumulated in a time series.

Then, on the basis of the predicted position of the intermediate object at the time Tₙ, the second target position P_{target2} of the robot 1 at the time Tₙ is set by the robot control unit 15 so that the relative positional relationship between the intermediate object and the robot 1 as viewed from the target person at the time Tₙ becomes different from the relative positional relationship between the intermediate object and the robot 1 as viewed from the target person at the current time Tₘ.

Here, when it is possible to set the second target position P_{target2} in an imaginary line L orthogonal to the direction of a visual line 64 of the target person, the second target position P_{target2} is set in the imaginary line L.

When both the target person and the intermediate object move, the second target position P_{target2} prescribing the first action is set as follows so that the relative positional relationship between the robot 1 and the intermediate object as viewed from the target person is changed.

That is, the position of the target person at the time Tₙ after the current time Tₘ is predicted by the object position prediction unit 21 from information regarding the past time-series position of the target person obtained on the basis of an environment map accumulated in a times series. Then, the second target position P_{target2} is set with consideration given to the predicted position of the intermediate object at the time Tₙ and the predicted position of the target person at the time Tₙ.

Further, when the intermediate object is a mobile object, the first action of the robot 1 is desirably controlled so as not to be similar to the action of the intermediate object. The first action of the mobile object is controlled so as not to be similar to the action of the intermediate object as described above, whereby the gaze determination of the target person may be more accurately performed.

In the example shown in FIG. 1, the user U3 riding on the rocking horse 66 that is an intermediate object is a mobile object that repeatedly swings back and forth, and it is predicted by the object position prediction unit 21 that the position of the intermediate object at time Tₙ after current time Tₘ is a position determined according to the back-and-forth swinging action of the intermediate object. On the basis of a prediction result, the first action of the robot 1 is controlled to linearly move so as not to be similar to the back-and-forth swinging action of the user U3 riding on the rocking horse 66.

Hereinafter, a method for generating first action not similar to the action of a mobile object existing around the robot 1 will be described. The mobile object existing around the robot 1 includes objects other than target persons and also includes intermediate objects.

(Example of Method for Generating First Action not Similar to Action of Surrounding Mobile Object)

Using FIGS. 11 to 14, an example of a method for generating first action not similar to the action of a mobile object existing around the robot 1 will be described.

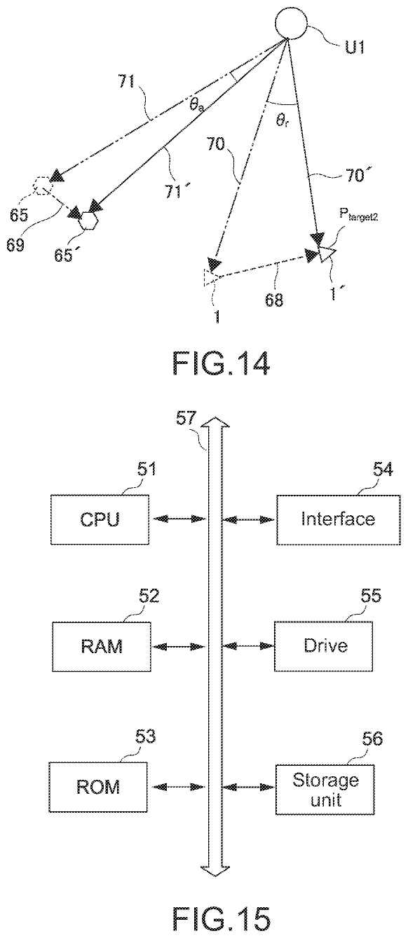

FIGS. 11 to 14 are views for describing a method for generating first action. FIGS. 11 to 13 are schematic views of the living room 60 that is real space as viewed from above. FIG. 14 is a view for describing a method for calculating a second target position prescribing first action not similar to the action of a surrounding mobile object.

In the figures, a circle represents the user U, squares represent stationary objects, a triangle represents the robot 1, and a hexagon represents a surrounding mobile object. Here, a cleaning robot 65 acting as a surrounding mobile object other than a person who is a gaze determination target will be exemplified.

As shown in FIG. 11, the past action of the cleaning robot 65 is acquired by the object position prediction unit 21 on the basis of an environment map accumulated in a time series. In FIGS. 11 to 13, black points and dashed lines represent a velocity vector 75 representing the past motion of the cleaning robot 65.

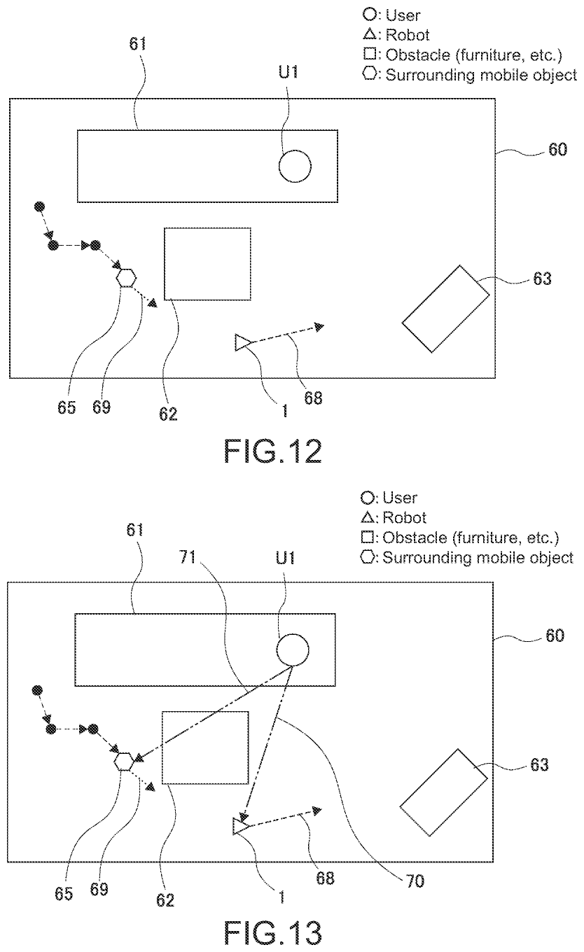

Next, as shown in FIG. 12, the motion of the cleaning robot 65 at time after current time is predicted by the object position prediction unit 21 on the basis of the environment map accumulated in a time series. In the figure, a dotted line represents a predicted velocity vector 69 of the cleaning robot 65. Note that the robot 1 has its own velocity vector 68 as control information.

Next, as shown in FIG. 13, a temporary visual line vector 70 directed from the user U1 to the robot 1 and a temporary visual line vector 71 (hereinafter called a temporary visual line vector) directed from the user U1 to the cleaning robot 65 are calculated on the basis of information regarding the positional relationship between the robot 1 and the user U1 that is measured by the depth sensor 42 and information regarding the positional relationship between the user U1 and the cleaning robot 65.

In FIG. 14, a hexagon indicated by a dotted line represents the cleaning robot 65 at current time Tₖ. At this time, a temporary visual line vector is denoted by symbol 71. A hexagon indicated by a solid line represents a cleaning robot 65′ at time Tₖ₊₁ after the current time. At this time, a temporary visual line vector is denoted by symbol 71′.

In FIG. 14, a triangle indicated by a dotted line represents the robot 1 at the current time Tₖ. At this time, a temporary visual line vector is denoted by symbol 70. A triangle indicated by a solid line represents a robot 1′ at the time Tₖ₊₁ after the current time. At this time, a temporary visual line vector is denoted by symbol 70′. The position of the triangle indicated by the solid line becomes a second target position P_{target2} prescribing the first action of the robot 1.

As shown in FIG. 14, the similarity between a time-series change from the temporary visual line vector 70 to the temporary visual line vector 70′ and a time-series change from the temporary visual line vector 71 to the temporary visual line vector 71′ is calculated on the basis of the velocity vector 68 of the robot 1, the predicted velocity vector 69 of the cleaning robot 65, the temporary visual line vector 70, and the temporary visual line vector 71, and the robot control signal of the first action is generated so that the similarity becomes lower than a threshold.

Specifically, in the robot 1, the temporary visual line vector 70′ at the time Tₖ₊₁ is calculated, and an angle θᵣ formed by the temporary visual line vector 70′ and the temporary visual line vector 70 at the time Tₖ is calculated. Similarly, in the cleaning robot 65, the temporary visual line vector 71′ at the time Tₖ₊₁ is calculated, and an angle θₐ formed by the temporary visual line vector 71′ and the temporary visual line vector 71 at the time Tₖ is calculated.

When the difference between the angle θᵣ and the angle θₐ is lower than a threshold determined according to accuracy in estimating the visual line of the user, for example, angular resolution, it may be determined that the similarity is low and the action of the robot 1 is not similar to the action of the cleaning robot 65.

Accordingly, when a mobile object exists around the robot 1, a robot control signal relating to first action is generated so that the difference between an angle θᵣ and an angle θₐ becomes higher than a threshold. Thus, since the first action is action not similar to the action of the surrounding mobile object, it is possible to more remarkably detect a change in the visual line of a person who is a gaze determination target. Thus, accuracy in determining whether the target person is gazing the robot 1 is improved.

On the other hand, when the difference between the angle θᵣ and the angle θₐ is less than or equal to a threshold determined according to accuracy in estimating a visual line, for example, angular resolution, it may be determined that the similarity is high and the action of the robot 1 is similar to the action of the cleaning robot 65. In this case, it seems to be difficult to perform a gaze determination for the user U1 based on a change in the visual line of the user U1.

In order to take first action not similar to the action of the cleaning robot 65 acting as a mobile object around the robot 1 as described above, the movement angle (θₐ) of the temporary visual line vector of a user's visual line in a case in which it is assumed that a user is gazing the cleaning robot 65 is first calculated on the basis of a predicted movement track during a period from time Tₖ to time Tₖ₊₁ that is calculated from information regarding the past movement of the cleaning robot (surrounding mobile object) 65.

Next, a second target position P_{target2} is set on the basis of the position of the robot 1 at the time Tₖ and the temporary visual line vector at the time Tₖ so that the difference between the movement angle (θᵣ) of the temporary visual line vector of the user's visual line in a case in which the user is gazing the robot 1 and the movement angle θₐ becomes higher than a threshold.

Thus, a mobile object is controlled so as to move in a direction different from the movement direction of an intermediate object, as viewed from a user, and performs action not similar to the action of the intermediate object.

(Hardware Configuration)

The above series of processing relating to a gaze determination may be realized by hardware or software. When the series of processing or a part of the processing is performed by software, a program constituting the software is performed using a computer incorporated in dedicated hardware, a general-purpose computer shown in, for example, FIG. 15, or the like.

In FIG. 15, a CPU (Central Processing Unit) 51 controls the general operation of the general-purpose computer. A ROM (Read Only Memory) 53 stores a program or data in which a part or all of the series of processing is described. A RAM (Random Access Memory) 52 temporarily stores a program, data, or the like used by the CPU 51 to perform the processing.

The CPU 51, the RAM 52, and the ROM 53 are connected to each other via a bus 57. In addition, an interface 54, a drive 55, and a storage unit 56 are connected to the bus 57.

The interface 54 performs the input/output of data with the input/output unit 40 such as a camera, a depth sensor, a microphone, a touch sensor, a speaker, and an LED indicator. Further, the interface 54 performs the input/output of data with the movement mechanism 34.

The drive 55 is provided in the general-purpose computer as occasion demands and drives a removable medium. The removable medium is a recording medium that records a program capable of being performed by a computer and includes a magnetic disk, an optical disk, a magnetic optical disk, a semiconductor memory, or the like.

The storage unit 56 includes, for example, a hard disk and stores a program or data.

When the series of processing is performed, a program stored in the ROM 53, the storage unit 56, or removable medium attached to the drive 55 that is shown in, for example, FIG. 15 is read by the RAM 52 and performed by the CPU 51.

As described above, in the present embodiment, the position of the robot 1 is controlled so as to have a movement path suitable for a gaze determination even if an intermediate object exists between a person who is a gaze determination target and the robot 1. Therefore, gaze determination processing may be accurately performed. Thus, the robot 1 can take more proper action for a user on the basis of a gaze determination result and perform natural communication.

### Second Embodiment

The first embodiment exemplifies a case in which a second target position is set in an imaginary line L orthogonal to the visual line vector of a user when the robot control signal of first action for a gaze determination is generated. However, the control of the first action is not limited to this.

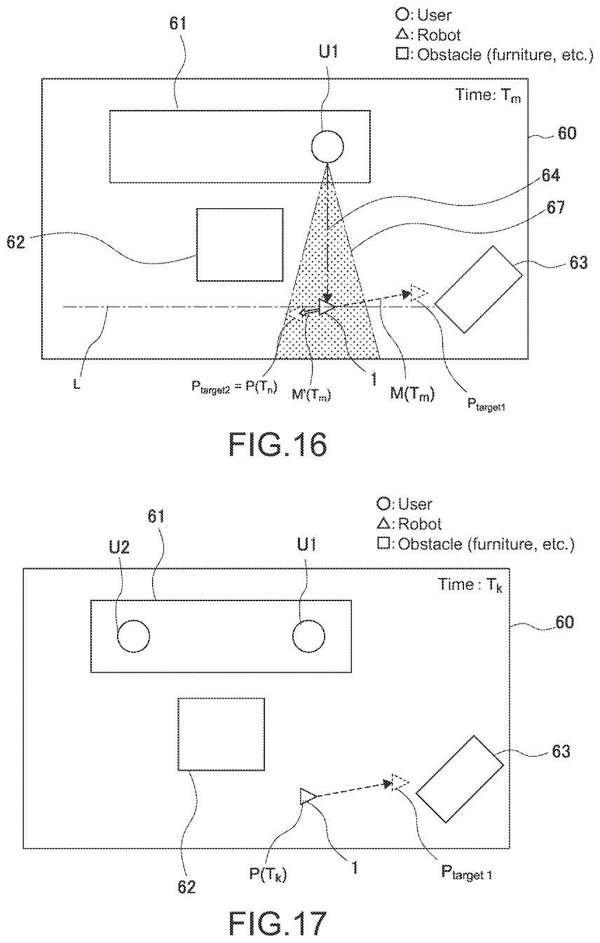

Hereinafter, a specific example will be described using FIG. 16. The same configurations as those described above will be denoted by the same symbols, and their descriptions will be omitted in some cases. FIG. 16 is a schematic view of a living room 60 that is real space as viewed from above.

As in the present embodiment, the first action is action different from action at a time immediately before the first action is taken and may be controlled with a second target position P_{target2} set at the position most distant from a position at which the robot 1 exists at the time immediately before the first action is taken, the position being set in a region 67 satisfying the condition that a difference in the angle of the visual line of a user who follows a robot 1 with his/her eyes becomes within 30 degrees per second and placed on a vector in a direction different by 180 degrees from the direction of a motion vector at the time immediately before the first action is taken.

As shown in FIG. 16, in the present embodiment, the second target position P_{target2} is set at the position most distant from a current position, the position being placed on a motion vector M′(Tₘ) obtained by rotating a motion vector M(Tₘ) at current time Tₘ by 180 degrees and set in the region 67 in which the user can naturally follow the robot 1 with his/her eyes. That is, the movement direction of the first action of the robot 1 is the direction different by 180 degrees from the movement direction of the action at the time immediately before the first action is taken.

By the employment of such a method of the present embodiment, it is possible to make a user easily follow the robot 1 with his/her eyes and easily perform a gaze determination in a case in which accuracy in estimating the visual line vector of the user is low, a case in which the visual line vector of the user is not directed to the robot 1 but the user is possibly looking at the robot 1, a case in which the estimation of imaginary lines from the respective visual line vectors of a plurality of users is difficult, a case in which a multiplicity of mobile objects exists and the estimation of action different from the action of the mobile objects is difficult, or the like. Accordingly, accuracy in determining the gazing of a visual line may be improved.

### Third Embodiment

The above embodiments exemplify cases in which a person exists as a gaze determination target. The present embodiment describes a case in which there exist multiple people as gaze determination targets using FIGS. 17 to 20. Note that the description of the same processing as that performed when a person exists as a gaze determination target will be omitted in some cases. Further, the same configurations as those described above will be denoted by the same symbols, and their descriptions will be omitted in some cases. Here, a method for calculating imaginary lines in a case in which there exists a plurality of users will be mainly described.

Each of FIGS. 17 to 20 is a schematic view of a living room 60 that is real space as viewed from above. In the living room 60, two users U1 and U2 sit on a sofa 61. Here, the two users U1 and U2 are persons who are gaze determination targets.

FIG. 17 shows a state in which a robot 1 is located at a position P(Tₖ) at time Tₖ and is moving to a first target position P_{target1}.

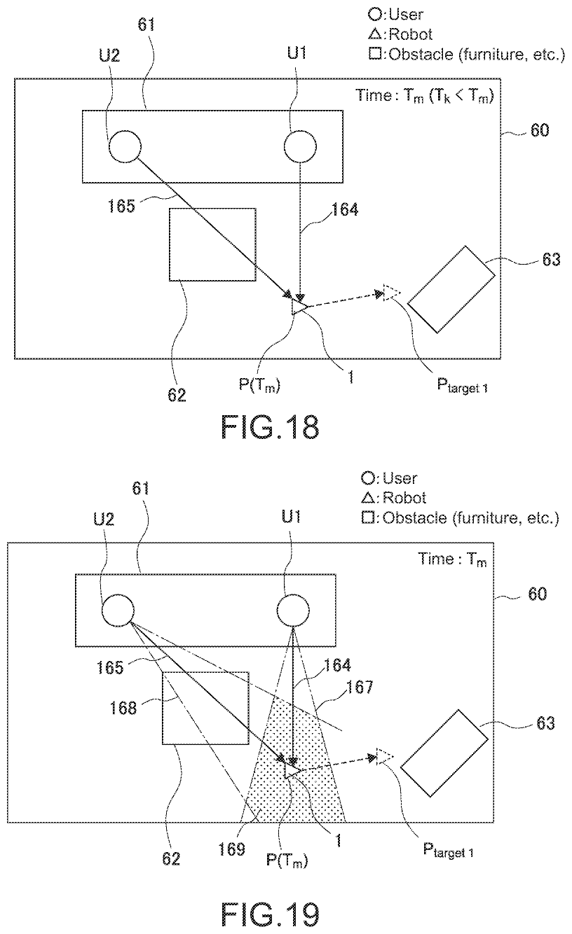

Next, as shown in FIG. 18, when the robot 1 is located at a position P(Tₘ) at time Tₘ (Tₖ<Tₘ) during the movement of the robot 1, a visual line 164 from the user U1 and a visual line 165 from a user U2 are detected by a face-and-visual-line detection unit 17. The visual lines 164 (and 165) are the visual lines of the user U1 (and the user U2) at a time immediately before first action starts.

Gaze determination processing is not performed when it is determined by a visual line determination unit 18 that both the visual line 164 of the user U1 and the visual line 165 of the user U2 are not directed to the robot 1.

When it is determined by the visual line determination unit 18 that only one of the visual line 164 of the user U1 and the visual line 165 of the user U2 is directed to the robot 1, a series of processing relating to the gaze determination processing described in the first embodiment is performed with a person assumed to be turning his/her eyes to the robot 1 as a target person for the gaze determination processing.

When it is determined by the visual line determination unit 18 that both the visual line 164 of the user U1 and the visual line 165 of the user U2 are directed to the robot 1, a region 167 in which the user U1 can naturally follow the robot 1 with his/her eyes is estimated by the robot control unit 15 as shown in FIG. 19 on the basis of information regarding the distance between the robot 1 and the user U1 that is measured by the depth sensor 42 and the visual line vector of the visual line 164.

Similarly, a region 168 in which the user U2 can naturally follow the robot 1 with his/her eyes is estimated on the basis of information regarding the distance between the robot 1 and the user U2 that is measured by the depth sensor 42 and the visual line vector of the visual line 165.

Next, a common region 169 in which the estimated region 167 in which the user U1 can follow the robot 1 with the eyes and the estimated region 168 in which the user U2 can follow the robot 1 with the eyes overlap each other is estimated by the robot control unit 15. In FIG. 19, the common region 169 in which it is estimated that both the users U1 and U2 are allowed to follow the robot 1 with the eyes is indicated by a dot pattern.

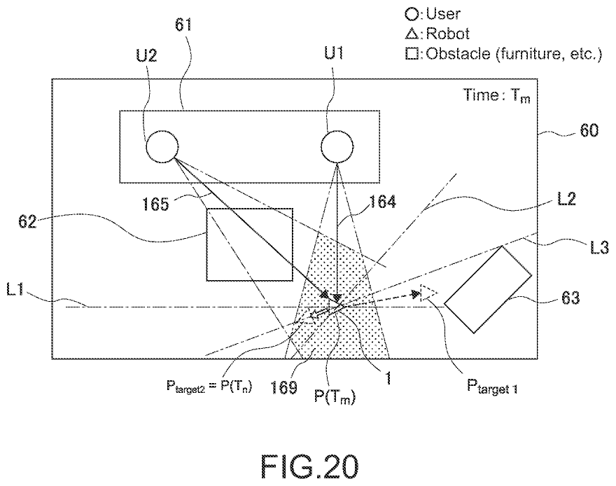

Next, as shown in FIG. 20, an imaginary line L1 orthogonal to the vector of the visual line 164 is estimated by the robot control unit 15. Similarly, an imaginary line L2 orthogonal to the vector of the visual line 165 is estimated.

Next, an imaginary line L3 dividing an angle formed by the imaginary line L1 and the imaginary line L2 that cross each other into two equal parts is calculated.

Next, a second target position P_{target2} is set by the robot control unit 15 so that the second target position P_{target2} falls within the common region 169 in which both the users U1 and U2 are allowed to follow the robot 1 with the eyes and is located in the imaginary line L3, and an angle formed by a motion vector from a position P(Tₘ) to a first target position P_{target1} and a motion vector from the position P(Tₘ) to the second target position P_{target2} becomes maximum.

Next, the control signal of first action taken by the robot 1 to reach the second target position P_{target2} at time Tₙ from the position P(Tₘ) is generated by the robot control unit 15.

As described above, when there exist multiple people as gaze determination targets, a second target position P_{target2} is set on a line other than the visual line vectors of the respective visual lines of the plurality of gaze determination targets at a time immediately before first action starts and the extension lines of the visual line vectors.

Here, a case in which two persons exist as gaze determination targets is described. However, when three or more persons exist as gaze determination targes, the above imaginary line L3 may be calculated as follows.

It is assumed that k (k is an integer of three or more) persons exist as gaze determination targets and k imaginary lines orthogonal to the visual line vectors of the respective target persons exit. k−1 lines dividing an angle formed by two adjacent imaginary lines into two equal parts may be drawn. In addition, as for the k−1 equally divided lines, k−2 lines dividing an angle formed by the adjacent equally divided lines into two equal parts may be drawn. A bisector is finally calculated by repeatedly performing the processing, and the line forms an imaginary line L3.

Note that when it is difficult to estimate imaginary lines from the respective visual line vectors of a plurality of users, the robot may only be caused to take the first action described in the second embodiment.

### Other Embodiments

The embodiments of the present technology are not limited to the embodiments described above but may be modified in various ways without departing from the spirit of the present technology.

For example, the above embodiments exemplify cases in which an intermediate object exists in real space, but the present technology may be applied to other cases.

As an example, the present technology may also be applied to a case in which a user wears a head mounted type display device (HMD: Head Mounted Display), a robot 1 acting as a real object is reflected in a display image presented to the user by the HMD, and an imaginary intermediate object exists between the user wearing the HMD and the robot 1.

Examples of a HMD include a see-through type HMD, a video see-through type HMD, and a retina projection type HMD. These HMDs are controlled by the display image control unit of the HMDs to be capable of displaying an image in which an image of an imaginary object is superimposed on an optical image of a real object positioned in real space on the basis of an AR (Augmented Reality) technology.

When the present technology is applied to an HMD, a control unit 10 of a robot 1 is configured to be capable of acquiring information regarding the position, the shape, or the like of an intermediate object at current time from the display image control unit of the HMD. However, the control unit 10 of the robot 1 is not allowed to control the action of the intermediate object. The action of the imaginary intermediate object in a display image presented by the HMD is controlled by the display image control unit of the HMD.

Note that the control unit 10 of the robot 1 may or may not be configured to be capable of acquiring information regarding the action of the intermediate object at time after current time.

When the information regarding the action of the intermediate object at the time after the current time is capable of being acquired from the control unit of the HMD by the control unit 10, the control signal of first action taken by the robot 1 for a gaze determination is generated using the information regarding the action.

When the information regarding the action of the intermediate object at the time after the current time is not capable of being acquired, the action at the time after the current time is predicted from the past action of the intermediate object by the control unit 10 like the first embodiment. Using a prediction result, the control signal of the first action for the gaze determination is generated.

When the user wears the HMD, the visual line of the user may be detected by a visual line detection unit installed in the HMD. The detection of the visual line of the user will be described below.

A display image is displayed on the HMD, and the user is looking at the image with his/her right and left eyes. The visual line detection unit installed in the HMD includes an infrared LED, an infrared camera or a PSD (Position Sensitive Detector) sensor, and an image analysis device.

The infrared LED applies infrared rays to the respective right and left eyes of the user. The infrared camera or the PSD sensor captures the respective right and left eyes of the user and supplies the data to the image analysis device. The image analysis device specifies the reflected positions of the infrared rays in corneas and the positions of pupils from the shot images of the right and left eyes and specifies the visual line of the user from the positional relationships between the reflected positions and the positions of the pupils.

Note that a method for detecting the visual line is not limited to this. For example, a general method such as a technology in which the right and left eyes are shot by a visible light camera and the visual line is specified from the positional relationship between the inner corners of the eyes and irises may be employed.

Further, the above embodiments exemplify a case in which the control unit 10 that performs the series of processing relating to a gaze determination is installed in the robot 1. However, the control unit 10 may be installed on a cloud server or in another equipment. In this case, the cloud server or the other equipment acts as an information processing apparatus. Further, a part of the control unit 10 may be installed on a cloud server or in another equipment, and the rest of the control unit 10 may be installed in the robot 1.

Note that the present technology may also employ the following configurations.

(1) An information processing apparatus including:

a mobile object control unit that controls, when an intermediate object is determined to be situated between a user and a mobile object, the mobile object so that a relative positional relationship between the mobile object and the intermediate object as viewed from the user is changed, the mobile object having a movement mechanism, the user and the mobile object being in real space, the mobile object control unit controlling the mobile object on the basis of information regarding a visual line of the user that is acquired after the relative positional relationship is changed.

(2) The information processing apparatus according to (1), in which

the mobile object control unit controls the mobile object so that the mobile object after the change in the relative positional relationship is located at a position other than a position in a direction of the visual line of the user at a time immediately before the relative positional relationship is changed.

(3) The information processing apparatus according to (1) or (2), in which

the mobile object control unit controls the mobile object so that the mobile object after the change in the relative positional relationship is located in an imaginary line orthogonal to the line of the visual line.

(4) The information processing apparatus according to any one of (1) to (3), in which

there exists a plurality of the users, and

the mobile object control unit controls the mobile object so that the mobile object after the change in the relative positional relationship is located at a position other than positions in visual-line directions of the respective visual lines of the plurality of the users at the time immediately before the relative positional relationship is changed.

(5) The information processing apparatus according to any one of (1) to (4), in which

the mobile object control unit controls the mobile object so that action of the mobile object acting so that the relative positional relationship is changed, is not similar to action of the intermediate object, as viewed from the user.

(6) The information processing apparatus according to any one of (1) to (5), in which

the mobile object control unit controls the mobile object so that the mobile object moves in a direction different from a movement direction of the intermediate object, as viewed from the user.

(7) The information processing apparatus according to any one of (1) to (6), in which

the mobile object control unit controls the mobile object using a predicted position of the intermediate object that is predicted on the basis of a temporal change in information regarding a past position of the moving intermediate object.

(8) The information processing apparatus according to any one of (1) to (7), in which

the mobile object control unit controls the mobile object so that the mobile object takes action different from action of the mobile object that is taken immediately before the relative positional relationship is changed and so that the relative positional relationship is changed.

(9) The information processing apparatus according to any one of (1) to (8), in which

the mobile object control unit controls the mobile object so that the mobile object moves in a movement direction different from a direction of movement of the mobile object that is performed immediately before the relative positional relationship is changed and so that the relative positional relationship is changed.

(10) The information processing apparatus according to any one of (1) to (9), in which

the mobile object control unit controls the mobile object so that the mobile object moves in a direction different by 180 degrees from the direction of the movement of the mobile object that is performed immediately before the relative positional relationship is changed and so that the relative positional relationship is changed.

(11) The information processing apparatus according to any one of (1) to (10), in which

the mobile object control unit controls the mobile object so that the mobile object moves at a speed that enables the user to follow the mobile object with an eye and so that the relative positional relationship is changed.

(12) The information processing apparatus according to any one of (1) to (11), in which

the mobile object is a mobile body having the movement mechanism.

(13) The information processing apparatus according to (12), in which

the mobile body is capable of moving on the ground.

(14) The information processing apparatus according to (12), in which

the mobile body is capable of flying.

(15) The information processing apparatus according to any one of (1) to (14), in which

the information processing apparatus is the mobile object including the movement mechanism and the mobile object control unit.

(16) The information processing apparatus according to any one of (1) to (15), in which

the mobile object includes an indicator indicating that the mobile object is on standby for receiving an instruction from the user.

(17) The information processing apparatus according to any one of (1) to (16), in which

the mobile object includes an image acquisition unit that acquires information regarding an image of a surrounding environment, and

the mobile object control unit controls the mobile object on the basis of the information regarding the visual line of the user, the information regarding the visual line of the user being acquired using the information regarding the image.

(18) The information processing apparatus according to (17), in which

the image acquisition unit includes a depth sensor.

(19) An information processing method including:

controlling, when an intermediate object is determined to be situated between a user and a mobile object, the mobile object so that a relative positional relationship between the mobile object and the intermediate object as viewed from the user is changed, the mobile object having a movement mechanism, the user and the mobile object being in real space; and

controlling the mobile object on the basis of information regarding a visual line of the user that is acquired after the relative positional relationship is changed.

(20) A program that causes an information processing apparatus to perform processing including:

controlling, when an intermediate object is determined to be situated between a user and a mobile object, the mobile object so that a relative positional relationship between the mobile object and the intermediate object as viewed from the user is changed, the mobile object having a movement mechanism, the user and the mobile object being in real space; and

controlling the mobile object on the basis of information regarding a visual line of the user that is acquired after the relative positional relationship is changed.

### REFERENCE SIGNS LIST

1 robot (mobile object, information processing apparatus, autonomous action robot)
11 three-dimensional sensing unit
13 self-position estimation unit
14 environment map generation unit
15 robot control unit (mobile object control unit)
16 object detection unit
17 face-and-visual-line detection unit (visual line detection unit)
18 visual line determination unit
20 gaze determination unit
34 movement mechanism
41 camera (image acquisition unit)
42 depth sensor (image acquisition unit, depth sensor)
46 LED indicator (indicator)
60 living room (real space)
64, 164, 165 visual line of user
66 rocking horse (intermediate object)
L, L1, L2, L3 imaginary line
U1 user
U3 user (intermediate object)

1. An information processing apparatus comprising:
a mobile object control unit that controls, when an intermediate object is determined to be situated between a user and a mobile object, the mobile object so that a relative positional relationship between the mobile object and the intermediate object as viewed from the user is changed, the mobile object having a movement mechanism, the user and the mobile object being in real space, the mobile object control unit controlling the mobile object on a basis of information regarding a visual line of the user that is acquired after the relative positional relationship is changed.

2. The information processing apparatus according to claim 1, wherein
the mobile object control unit controls the mobile object so that the mobile object after the change in the relative positional relationship is located at a position other than a position in a direction of the visual line of the user at a time immediately before the relative positional relationship is changed.

3. The information processing apparatus according to claim 2, wherein
the mobile object control unit controls the mobile object so that the mobile object after the change in the relative positional relationship is located in an imaginary line orthogonal to the direction of the visual line.

4. The information processing apparatus according to claim 2, wherein
there exists a plurality of the users, and
the mobile object control unit controls the mobile object so that the mobile object after the change in the relative positional relationship is located at a position other than positions in visual-line directions of the respective visual lines of the plurality of the users at the time immediately before the relative positional relationship is changed.

5. The information processing apparatus according to claim 2, wherein
the mobile object control unit controls the mobile object so that action of the mobile object acting so that the relative positional relationship is changed, is not similar to action of the intermediate object, as viewed from the user.

6. The information processing apparatus according to claim 5, wherein
the mobile object control unit controls the mobile object so that the mobile object moves in a direction different from a movement direction of the intermediate object, as viewed from the user.

7. The information processing apparatus according to claim 6, wherein
the mobile object control unit controls the mobile object using a predicted position of the intermediate object that is predicted on a basis of a temporal change in information regarding a past position of the moving intermediate object.

8. The information processing apparatus according to claim 5, wherein
the mobile object control unit controls the mobile object so that the mobile object takes action different from action of the mobile object that is taken immediately before the relative positional relationship is changed and so that the relative positional relationship is changed.

9. The information processing apparatus according to claim 8, wherein
the mobile object control unit controls the mobile object so that the mobile object moves in a movement direction different from a direction of movement of the mobile object that is performed immediately before the relative positional relationship is changed and so that the relative positional relationship is changed.

10. The information processing apparatus according to claim 9, wherein
the mobile object control unit controls the mobile object so that the mobile object moves in a direction different by 180 degrees from the direction of the movement of the mobile object that is performed immediately before the relative positional relationship is changed and so that the relative positional relationship is changed.

11. The information processing apparatus according to claim 8, wherein
the mobile object control unit controls the mobile object so that the mobile object moves at a speed that enables the user to follow the mobile object with an eye and so that the relative positional relationship is changed.

12. The information processing apparatus according to claim 11, wherein
the mobile object is a mobile body having the movement mechanism.

13. The information processing apparatus according to claim 12, wherein
the mobile body is capable of moving on the ground.

14. The information processing apparatus according to claim 12, wherein
the mobile body is capable of flying.

15. The information processing apparatus according to claim 13, wherein
the information processing apparatus is the mobile object including the movement mechanism and the mobile object control unit.

16. The information processing apparatus according to claim 15, wherein
the mobile object includes an indicator indicating that the mobile object is on standby for receiving an instruction from the user.

17. The information processing apparatus according to claim 16, wherein
the mobile object includes an image acquisition unit that acquires information regarding an image of a surrounding environment, and
the mobile object control unit controls the mobile object on a basis of the information regarding the visual line of the user, the information regarding the visual line of the user being acquired using the information regarding the image.

18. The information processing apparatus according to claim 17, wherein
the image acquisition unit includes a depth sensor.

19. An information processing method comprising:
controlling, when an intermediate object is determined to be situated between a user and a mobile object, the mobile object so that a relative positional relationship between the mobile object and the intermediate object as viewed from the user is changed, the mobile object having a movement mechanism, the user and the mobile object being in real space; and
controlling the mobile object on a basis of information regarding a visual line of the user that is acquired after the relative positional relationship is changed.

20. A program that causes an information processing apparatus to perform processing comprising:
controlling, when an intermediate object is determined to be situated between a user and a mobile object, the mobile object so that a relative positional relationship between the mobile object and the intermediate object as viewed from the user is changed, the mobile object having a movement mechanism, the user and the mobile object being in real space; and
controlling the mobile object on a basis of information regarding a visual line of the user that is acquired after the relative positional relationship is changed.
